(19) United States
(12) Patent Application Publication
(10) Pub. No.: US 2004/0075774 A1
(43) Pub. Date: Apr. 22, 2004

(54) System and method for providing on-demand data information on a television display device using a radio tuner

(75) Inventors: Matthew Chang, San Diego, CA (US); Greg Gudorf, San Diego, CA (US); Aaron Dew, San Diego, CA (US); Anthony Creed, San Diego, CA (US); Rolf Toft, San Francisco, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION; SONY ELECTRONICS, INC.

(21) Appl. No.: 10/273,758

(22) Filed: Oct. 18, 2002

(51) Int. Cl. H04N 5/46

(52) U.S. Cl. 348/729; 348/552

(57) ABSTRACT

A system and method for providing on demand information at a display device includes a microprocessor that is connected to a radio data service signal receiver and a display device. The radio signal contains the data source for the on-demand content rather than the display device tuner. The microprocessor causes information from the radio data service signal to be decoded and displayed at the display device when requested by a user.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A COMPUTER PROGRAM APPENDIX

Not Applicable

### BACKGROUND OF THE INVENTION

1. Field of the Invention

The present invention relates generally to television systems, and more particularly to a system and method displaying information on-demand.

2. Description of the Background Art

Televisions have become ubiquitous. They are used for entertainment purposes as well as to gain access to useful information such as news. Typically, news programs are broadcast at particular times of the day, e.g., morning, noon, early evening, and late evening. Moreover, conventional news programs follow a set format, i.e., headlines are first in the broadcast, weather information is given at a predetermined time into the broadcast, sporting news is given at a predetermined time into the broadcast, etc. Thus, if a user wants weather information, he or she must wait until that particular time in the broadcast and, unfortunately, the desired information is not available on-demand. Usage of running ticker tape like scrolling messages on the bottom of the screen are simple attempts to address this issue.

In recent years, television stations that broadcast only news or only weather or both have emerged. Although many of these stations broadcast their content twenty-four hours a day, seven days a week, they also follow a predetermined format and do not provide this information on demand. Again, if a user needs certain information such as weather, he or she must wait until that point in the broadcast.

Therefore, a need exists for a broadcast system that provides the viewer with the ability to access information such as weather, traffic, news, etc. on demand. The present invention satisfies this need, as well as others.

### BRIEF SUMMARY OF THE INVENTION

The present invention is a system and method for distribution and on demand displaying of local information and broadcast programming. In general terms, the system comprises a display device, a Radio Data Service (RDS) ready radio receiver or other radio receiver capable of receiving data (XM or other future digital radio formats, etc.), and a processor connected to the display device and the receiver. Additionally, media storage memory (RAM, hard disk drive, memory stick, etc) may be present to enable caching of data, speeding access to broadcast data. The processor causes data from the receiver to be displayed at the display device.

By way of example, and not of limitation, the system includes a memory storage that is accessible by the processor for storing data from the radio data service receiver. Additionally, simple localization information, such as viewer's zip code to more elaborate schemes such as use of GPS for location data, can be combined with stored RDS data in order to filter the stored results. This allows the information provided to be localized for the specific viewer.

Preferably, the data from the radio data service receiver includes audio data and/or video data. Also, the data from the radio data service receiver can include metatags that are useful by the computer for correlating map data to data from the radio data signal receiver. In a preferred embodiment, the standardized RDS data available from the radio data service receiver includes the specific categories flagged for traffic information and/or weather information. Preferably, the system also includes a remote control unit that is used to generate a signal for causing data from the radio data service receiver, which can be received real-time or can be received and stored, to be displayed at the display device. Additionally, there may be another command which will seek out latest updated data.

In another aspect of the present invention, a system for providing local information on demand includes a television and a radio receiver. The radio receiver receives Radio Data Service signals. This aspect further includes a processor that is connected to the television and radio receiver. The processor causes data from the radio data service signal to be broadcast at the television.

In yet another aspect of the present invention, a system for providing information on demand includes a display device and a signal receiver that receives radio data service signals. A processor is connected to the display device and the receiver. The processor causes data from the radio data service signal to be broadcast at the display device.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings that are for illustrative purposes only:

FIG. 1 is a block diagram of an information display system according to the present invention.

FIG. 2 is a flow chart of the operating logic of the present invention.

### DETAILED DESCRIPTION OF THE INVENTION

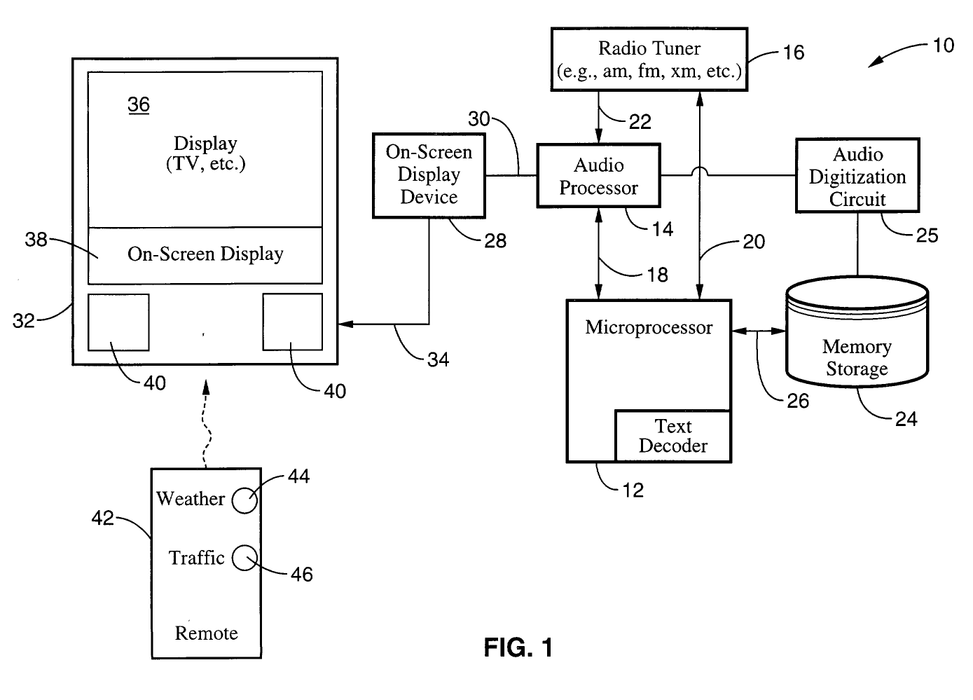

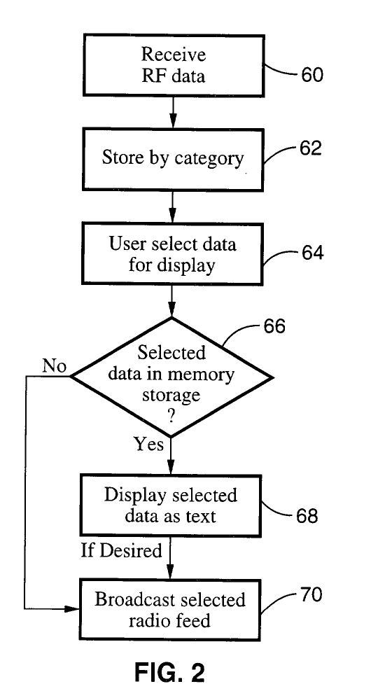

Referring more specifically to the drawings, for illustrative purposes the present invention is embodied in the apparatus generally shown in FIG. 1 and FIG. 2. It will be appreciated that the apparatus may vary as to configuration and as to details of the parts, and that the method may vary as to the specific steps and sequence, without departing from the basic concepts as disclosed herein.

Referring initially to FIG. 1, an information display system is shown, generally designated 10. As shown, the system 10 includes a microprocessor 12 to which an audio processor 14 and a radio tuner 16 can be connected via line 18 and line 20, respectively. Preferably, the radio tuner 16 is also connected to the audio processor 14 via line 22. FIG. 1 also shows that a memory storage 24 can be connected to the microprocessor 12 via line 26. It can be appreciated that the memory storage 24 can be RAM, hard disk drive, memory stick, flash memory, etc. The microprocessor 12 parses the radio signal and decodes the data (such as weather or traffic information) and stores it for later access in the memory storage 24. The microprocessor 12 can include a text decoder 15 for decoding text data embedded in the radio signal.

Additionally, as shown, the audio processor can also be connected to the memory storage 24 via digitization circuit 25 for storage and later retrieval along with text data. Moreover, the audio processor 14 can be connected to an on-screen display (OSD) device 28 via line 30. In turn, the OSD device 28 can be connected to a display device 32 via line 34. In a preferred embodiment, the display device 32 is a television, but it can be appreciated that it can be any other display device, e.g., a computer monitor, etc.

As shown in FIG. 1, the display device 32 includes a display screen 36 at which an on-screen display 38 can be viewed. The display device 32 can also include plural audio speakers 40. Also included in the preferred embodiment of the system 10 is a remote control unit 42. As shown, the remote control unit 42 includes a weather button 44 and a traffic button 46. As described in detail below, when either button 44, 46 is toggled weather information or traffic information can be provided at the on-screen display 38. On the other hand, when either button 44, 46 is toggled, an audio snippet can be transmitted through the speakers 40 if audio is stored in the memory storage 24 via the audio digitization circuit 48.

Referring now to FIG. 2, the method steps of the present invention are shown and commence at block 60 wherein radio frequency data is received at the radio tuner 16. It is to be understood that data such as weather information or traffic information can be broadcast by the existing Radio Data Service (RDS), or other audio broadcast means such as satellite radio (XM) or future high-definition digital radio broadcasts which carry data, and received at the radio tuner 16. Moving to block 62, the data is stored by category, e.g., weather, traffic, etc., at the memory storage 24. Thereafter, at block 64, a user can select data for display, e.g., text information or audio snippet from memory storage 24 or live audio broadcast from radio tuner 16 where the station is selected using category information decoded by the microprocessor 12. The user can select data for display by toggling a button on the remote control unit 42, e.g., the weather button 44 or the traffic button 46.

At decision diamond 66, it is determined whether the selected data is stored in the memory storage 24 or available real-time from the radio broadcast from the radio tuner 16. If so, the logic moves to block 68 and the data is displayed at the display device 32, e.g., within the on-screen display 38. If desired, the logic continues to block 70, where a radio feed corresponding to the selected data can be broadcast at the display device 32, e.g., through the speakers 40. Returning to decision diamond 66, if the selected data is not stored within the memory storage 24, the logic moves to block 70 and the radio feed corresponding to the selected data is broadcast at the display device 32.

Accordingly, it will be seen that this invention provides a system and method for providing on demand information at a display device 32 such as a television. This information can be provided on demand in response to a signal generated by a remote control unit 42. It can be appreciated that information other than weather and traffic information may be displayed or otherwise broadcast at the display device 32. For example, map information can be embedded in the RDS signal, received by the radio tuner 16, and in turn, broadcast at the display device 32. To facilitate this process the map information can be marked with metatags.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for displaying local information and broadcast programming, comprising:
a display device;
a radio data service receiver; and
a one processor connected to said display device and said radio data service receiver;
said processor configured to cause data from said radio data service receiver to be displayed at said display device.

2. A system as recited in claim 1, further comprising:
a memory storage device accessible to said processor for storing data from said radio data service receiver.

3. A system as recited in claim 2:
wherein said processor is configured to access said memory storage to retrieve map data therefrom;
said map data being correlated to data from said radio data service receiver for display on said television simultaneously with said data from said radio data service receiver.

4. A system as recited in claim 1:
wherein said data from said radio data service receiver includes audio data.

5. A system as recited in claim 1:
wherein said data from said radio data service receiver includes audio data and video data.

6. A system as recited in claim 1:
wherein said data from said radio data service receiver includes metatags;
said metatags being used by said processor for correlating map data to data from said radio data signal receiver.

7. A system as recited in claim 1:
wherein said data from said radio data service receiver includes traffic information.

8. A system as recited in claim 1:
wherein said data from said radio data service receiver includes weather information.

9. A system as recited in claim 1:
wherein said data from said radio data service receiver includes at least one metatag;
said metatag being used by said processor for tuning to live content correlated to said metatag.

10. A system as recited in claim 1:
wherein said data from said radio data service receiver is used to determine local information to filter data for that area.

11. A system as recited in claim 2:
wherein said memory is a removable media.

12. A system as recited in claim 2:
wherein said memory is mass storage media.

13. A system as recited in claim 1, further comprising:
a remote control unit;
said remote control unit configured to generate a signal for causing data from said radio data service receiver to be broadcast at said display device.

14. A system for providing local information on demand, comprising:
a television receiver;
a radio receiver capable of receiving at least one radio data service signal; and
a processor connected to said television receiver and said radio receiver;
said processor configured to cause data from said radio data service signal to be decoded and displayed at said television receiver.

15. A system as recited in claim 14:
wherein said television receiver includes an on-screen display for receipt of data broadcasted from said radio data service signal.

16. A system as recited in claim 14:
wherein said television receiver includes at least one speaker for receipt of data broadcasted from said radio data service signal.

17. A system as recited in claim 14, further comprising:
a memory storage device accessible to said processor for storing data from said radio data service signal.

18. A system as recited in claim 17:
wherein said processor is configured to access said memory storage to retrieve map data therefrom; and
wherein said map data is correlated to data from said radio data service signal for display on said television receiver simultaneously with said data from said radio data service signal.

19. A system as recited in claim 14:
wherein said data from said radio data service signal includes audio data.

20. A system as recited in claim 14:
wherein said data from said radio data service signal includes audio data and video data.

21. A system as recited in claim 18:
wherein said data from said radio data service receiver includes metatags;
said metatags being used by said processor for correlating map data to data from said radio data signal receiver.

22. A system as recited in claim 14:
wherein said data from said radio data service signal includes traffic information.

23. A system as recited in claim 14:
wherein said data from said radio data service signal includes weather information.

24. A system as recited in claim 14, further comprising:
a remote control unit;
said remote control unit configured to generate a signal for causing data from said radio data service signal to be broadcast at said display device.

25. A system as recited in claim 14:
wherein said data from said radio data service receiver includes at least one metatag;
said metatag being used by said processor for tuning to live content correlated to said metatag.

26. A system as recited in claim 14:
wherein said data from said radio data service receiver is used to determine local information to filter data for that area.

27. A system as recited in claim 17:
wherein said memory is a removable media.

28. A system as recited in claim 17:
wherein said memory is mass storage media.

29. A system for providing information on demand, comprising:
a display device;
a signal receiver configured to receive at least one radio data service signal; and
a processor connected to said display device and said receiver;
said processor configured to cause data from said radio data service signal to be broadcast at said display device.

30. A system as recited in claim 29:
wherein said display device includes a display screen for receipt of data broadcasted from said radio data service signal.

31. A system as recited in claim 29:
wherein said display device includes at least one speaker for receipt of data broadcasted from said radio data service signal.

32. A system as recited in claim 31, further comprising:
a memory storage device accessible to said processor for storing data from said radio data service signal.

33. A system as recited in claim 29:
wherein said processor is configured to access said memory storage to retrieve map data therefrom; and
wherein said map data is correlated to data from said radio data service signal for display on said display device simultaneously with said data from said radio data service signal.

34. A system as recited in claim 29:
wherein said data from said radio data service signal includes audio data.

35. A system as recited in claim 29:
wherein said data from said radio data service signal includes audio data and video data.

36. A system as recited in claim 33:
wherein said data from said radio data service receiver includes metatags;
said metatags being used by said processor for correlating map data to data from said radio data signal receiver.

37. A system as recited in claim 29:
wherein said data from said radio data service signal includes traffic information.

38. A system as recited in claim 29:
wherein said data from said radio data service signal includes weather information.

39. A system as recited in claim 29:
wherein said data from said radio data service receiver includes at least one metatag;
said metatag being used by said processor for tuning to live content correlated to said metatag.

40. A system as recited in claim 29:
wherein said data from said radio data service receiver is used to determine local information to filter data for that area.

41. A system as recited in claim 32:
wherein said memory is a removable media.

42. A system as recited in claim 32:
wherein said memory is mass storage media.

43. A system as recited in claim 33, further comprising:
a remote control unit;
said remote control unit configured to generate a signal for causing data from said radio data service signal to be broadcast at said display device.

44. A system for displaying local information and broadcast programming, comprising:
a display device;
a radio data service receiver; and
means for causing data from said radio data service receiver to be displayed at said display device.

45. A system as recited in claim 44:
wherein said means comprises a processor connected to said display device and said radio data service receiver.

46. A system as recited in claim 45, further comprising:
a memory storage device accessible to said processor for storing data from said radio data service receiver.

47. A system as recited in claim 45:
wherein said processor is configured to access said memory storage to retrieve map data therefrom;
said map data being correlated to data from said radio data service receiver for display on said television simultaneously with said data from said radio data service receiver.

48. A system as recited in claim 44:
wherein said data from said radio data service receiver includes audio data.

49. A system as recited in claim 44:
wherein said data from said radio data service receiver includes audio data and video data.

50. A system as recited in claim 45:
wherein said data from said radio data service receiver includes metatags;
said metatags being used by said processor for correlating map data to data from said radio data signal receiver.

51. A system as recited in claim 44:
wherein said data from said radio data service receiver includes traffic information.

52. A system as recited in claim 44:
wherein said data from said radio data service receiver includes weather information.

53. A system as recited in claim 44:
wherein said data from said radio data service receiver includes at least one metatag;
said metatag being used by said processor for tuning to live content correlated to said metatag.

54. A system as recited in claim 44:
wherein said data from said radio data service receiver is used to determine local information to filter data for that area.

55. A system as recited in claim 46:
wherein said memory is a removable media.

56. A system as recited in claim 46:
wherein said memory is mass storage media.

57. A system as recited in claim 44, further comprising:
a remote control unit;
said remote control unit configured to generate a signal for causing data from said radio data service receiver to be broadcast at said display device.

58. A system for displaying local information and broadcast programming, comprising:
a display device;
a radio data service receiver; and
a processor connected to said display device and said radio data service receiver;
said processor configured to cause data from said radio data service receiver to be displayed at said display device; and
a memory storage device accessible to said processor for storing data from said radio data service receiver;
audio data from said radio data service receiver being digitized and stored in said memory storage;
said audio data being flagged by metadata for indicating type.

59. A system as recited in claim 58, wherein said display device comprises:
a speaker;
said audio data being transmitted by said speaker.

60. A system as recited in claim 59, wherein said display device comprises:
an on-screen display;
text data from said radio data service receiver being displayed at said on-screen display while said audio data is transmitted.
